(19) United States
(12) Patent Application Publication
(10) Pub. No.: US 2005/0255202 A1
(43) Pub. Date: Nov. 17, 2005

(54) Food partical encapsulation preserving volatiles and preventing oxidation

(76) Inventors: Sean Mark Dalziel, Wilmington, DE (US); Thomas Friedmann, Hockessin, DE (US); George A. Schurr, Newark, DE (US)

Correspondence Address: EI du Pont de Nemours and Company;Legal - Patents, 4417 Lancaster Pike, Wilmington, DE, 19898, US

(21) Appl. No.: 10/520,539

(22) PCT Filed: Aug. 14, 2003
(86) PCT No.: PCT/US03/25868

§ 371 Date: Jan. 5, 2005

Related U.S. Application Data
(60) Provisional application No. 60/403,488, filed on Aug. 14, 2002.

(51) Int. Cl. A23B 4/00

(52) U.S. Cl. 426/302

(57) ABSTRACT

A process for encapsulating a solid food particle with a liquid encapsulating material comprising the steps of metering and encapsulation mixture (20) into a flow restrictor (14) concurrently a gas stream is introduced at inlet (22) into the flow restrictor there by atomizing the liquid encapsulating material and creating a turbulent flow zone at the outlet of the flow restrictor (14). Concomitant with metering the encapsulating material with the gas stream, solid food particulate (30) is introduced via hopper (28) to the turbulent zone at the outlet of the flow restrictor (14) wherein the solid food particles are encapsulating by the atomized encapsulating material, the encapsulated food particle inhibits environmental volatiles from diffusing into the food product while preventing oxidation of the food.

This application claims the benefit off U.S. Provisional Application No. 60/403,488, filed Aug. 14, 2002.

### FIELD OF THE INVENTION

The field of invention relates to processes for encapsulating a food particle with an encapsulating material.

### TECHNICAL BACKGROUND

A considerable number of food products are sold with surface coatings to enhance the value of the product. Examples of such coated food products include, but are not limited to, coffee grounds, flavoring agents, food ingredients, powdered dairy products, powdered soup products, powdered snack foods, powdered drink mixes, powdered health and fitness supplements, or baking goods. Many of these products are coated with sweeteners, flavorings, or other additives that enhance the product.

In many instances, the coated product is not uniformly coated by the coating process resulting in volatile losses and oxidation that, in turn, leads to aroma loss, favor loss, color loss, off-flavor creation, ingredient interactions, reduced nutritional content, and reduced shelf life.

Conventionally, spray drying, spray chilling, extrusion, fluid bed, or coacervation techniques are used in the food industry to coat food particles. For a review of these conventional coating/encapsulation techniques, see Gibbs et al. (1999) Int. J. Food Sci. Nutr. 50, 213-224. For example, U.S. Pat. No. 4,848,673, issued to Masuda et al describes a fluid bed coating apparatus and method.

In the food industry, coating/encapsulation techniques are typically used to coat/encapsulate microscopic food ingredients. For example, U.S. Pat. No. 6,245,366, issued to Popplewell and Porzio on Jun. 21, 2001, discloses fat-coated encapsulation compositions used to encapsulate, for example, flavorings, pharmaceutical agents, and fragrances. Encapsulation can be performed using any conventional coating/encapsulation technique, including spray drying, melt extrusion, coacervation, and freeze drying.

U.S. Pat. No. 6,126,974, issued to Ang on Oct. 3, 2000, describes the process of producing a food ingredient composition wherein the food ingredient composition is at least a partially encapsulated anti-caking agent. The encapsulating material is preferably sprayed onto the anti-caking agent in atomized form, where the encapsulating material is atomized using conventional atomization equipment.

U.S. Pat. No. 5,897,896, issued to Thomas on Apr. 27, 1999, discloses a multi-step coating process, wherein farinaceous/protein-containing materials are first coated with an emulsifier and second coated with a preground edible. Coating may be achieved by any process used in food technology, but it is preferred that the second layer is added via melted fat spraying or solid phase coating.

U.S. Pat. No. 5,607,708, issued to Fraser et al. on Mar. 4, 1997, discloses an encapsulated flavoring material, wherein a water-soluble outer shell stabilizes the volatile flavors of the core material until release during microwaving. The core material can be vegetable or animal oils or fats, with volatile flavors such as diacetyl, butyric acid, hexanoic acid, methyl sulfide, or mixtures thereof added to the core material.

U.S. Pat. No. 5,603,952, issued to Soper on Feb. 18, 1997, is directed to a process of microencapsulating food or flavor particles by complex coacervation with the advantage of coacervation taking place at elevated temperatures. The food/flavor particles encapsulated include vegetable oil, lemon oil, garlic flavor, apple flavor, and black pepper.

U.S. Pat. No. 4,931,284, issued to Ekman et al. on Jun. 5, 1990, discloses a lipid crystal encapsulation, wherein the encapsulated material is protected from oxidation and light decomposition.

U.S. Pat. No. 4,520,033, issued to Tuot on May 28, 1985, describes a process for producing aromatization capsules, especially capsules derived from the solids and distillates of coffee or tea. The core material is foamed and then sprayed onto a wall material of edible solids, wherein the wall material coats the foamed core material.

U.S. Patent Application No. 20010016220 to Jager et al. discloses a multifunctional, encapsulated, nutritive component consisting of a dietary fiber core and surrounding biologically active substances. The biologically active substances include microorganisms, prebiotic substances, enzymes, nutrients, plant constituents, and antioxidants. The encapsulation material can be a mono-, di-, or polysaccharide, an emulsifier, a peptide, a protein, or a prebiotic substance, or combinations thereof.

An apparatus and process for coating small solid particles, such as powdery or granular materials, are described in WO 97/07879 published Mar. 6, 1997, and assigned to E.I. du Pont de Nemours and Company. This process involves metering a liquid composition comprising a coating material, where the liquid composition is either a solution, slurry, or melt, into a flow restrictor and injecting a gas stream through the flow restrictor concurrently with the metering of the liquid composition to create a zone of turbulence at the outlet of the flow restrictor, thereby atomizing the liquid composition. The gas stream is heated prior to injecting it through the flow restrictor. A solid particle is added to the zone of turbulence concurrently with the metering of the liquid composition and the injection of the heated gas to mix the solid particle with the atomized liquid composition. The mixing at the zone of turbulence coats the solid particle with the coating material.

WO 97/07676 to E.I. du Pont de Nemours and Company discloses the apparatus of WO 97/07879, along with the use of the apparatus in a process for coating crop protection solid particles. Coatings are water-insoluble, and coating thicknesses are represented by percent rather than thickness.

Applicants' assignee's copending application having application Ser. No. 10/174,687, filed Jun. 19, 2002 and having Attorney Docket Number CL-1879 US NA discloses a process for dry coating a food particle having its largest diameter in the range from 0.5 mm to 20.0 mm with a liquid coating material. The coated food particle has a moisture level that is substantially the same as the moisture level of the uncoated food particle. Also disclosed is a process for encapsulating a frozen liquid particle having a size in the range from 5 micrometers to 5 millimeters with a liquid coating material.

Applicants' assignees' copending, concurrently filed herewith provisional applications having Attorney Docket numbers CL2101, CL2148, CL2149, CL2178 and PTI sp1255 disclose subject matter related to the present application, and are specifically incorporated herein by reference.

U.S. Pat. Nos. 3,241,520 and 3,253,944 disclose a particle coating method wherein relatively large pellets, granules and particles are suspended in a stream of air while coating material in a liquid form is mixed with the particles.

U.S. Pat. No. 6,224,939 B1 issued to Cherukuri et al May 1, 2001 describes a method and apparatus for the formation of an encapsulated feedstock product matrix. A solid product matrix additive is spray ejected in a free-flow condition. The matrix additive is encapsulated in its free-flow condition with a matrix encapsulant. Also described therein is an extrusion nozzle design for delivering the matrix encapsulant.

There is a need in the food industry for an economically efficient process for encapsulating food particles in such a manner that volatile diffusion into and out of the food, and oxidation from the environment, are minimized, thereby better preserving the aroma, flavor, color, nutritional content, and overall freshness of food.

### SUMMARY OF THE INVENTION

The present invention concerns a process for encapsulating a food particle with a liquid encapsulating material, the process comprising the steps of:
(a) metering a liquid-encapsulating material into a flow restrictor;
(b) injecting a gas stream through the flow restrictor concurrently with step (a) to (i) atomize the liquid encapsulating material and (ii) create turbulent flow of the gas stream and the atomized liquid encapsulating material, wherein the gas stream is optionally heated; and
(c) adding a food particle to the region of turbulent flow concurrently with steps (a) and (b), wherein the food particle mixes with the atomized liquid encapsulating material to provide an encapsulated food particle.

In a second embodiment, this process of the invention further comprises repeating steps (a)-(c) at least once wherein the liquid encapsulating material is the same or different.

The process of the invention can be used to encapsulate many forms of food particles including coffee grounds, flavoring agents, food ingredients, powdered dairy products, powdered soup products, powdered snack foods, powdered drink mixes, powdered health and fitness supplements, baking goods, and inert food additives.

The process of the invention can be practiced using many types of encapsulating materials, including those which comprise a sweetening agent, a food flavoring agent or enhancer, a food color, a food aroma agent, an anti-caking agent, a humectant, an antimicrobial agent, an antioxidant, a surface modifying agent, a moisture barrier, a shelf-life extending agent, a flavor retaining agent, a nutritional supplementing agent, a carbohydrate, a protein, a lipid, or a mineral.

Also of interest is an encapsulated food particle made by at least one of the processes of the invention.

### BRIEF DESCRIPTION OF THE DRAWINGS

FIG. 1 is a schematic diagram of a portion of a preferred apparatus in accordance with the present invention.

FIG. 2 is a cut-away, expanded, cross-sectional view of a portion of the apparatus shown in FIG. 1.

FIG. 3 is an alternative configuration of a preferred apparatus.

### DETAILED DESCRIPTION OF THE INVENTION

All patents, patent applications, and publications referred to herein are incorporated by reference in their entirety.

In the context of this disclosure, a number of terms shall be utilized.

The term “food particle” as used herein refers to any comestible, or a generally recognized as safe (“GRAS”) inert food additive, in particulate form. Food particles also include not only particles comprised entirely of food, but also inert particles or nonfood particles coated with food or food ingredients, or food particles coated with inert, or nonfood ingredients. For example, an inexpensive food particle, or an inexpensive non food GRAS particle, could be coated with a more expensive food ingredient and then encapsulated by the process of the invention, as a more convenient and economic way to deliver these expensive food ingredients to the market. An example of this could include expensive spices coated onto less expensive particles, and then encapsulated, yielding a final preserved spice particle with the flavoring characteristics of a particles comprised completely of that spice. Further included are food particles that are made by any of several commonly employed commercial particle techniques including, for example, spray dried emulsions. It is envisioned, for example, that a flavor oil in the form of an emulsion could be spray dried to particulate form, wherein these spray dried particulates would be suitable food particles of the invention. Further, for example, a flavor oil in the form of an emulsion could be particulated via an extrusion process, wherein these particles would also be suitable food particles to be encapsulated using the process of the invention.

The term “coating” as used herein refers to adherence, adsorption, loading and/or incorporation, to some extent, of at least one liquid coating material onto and/or into a particle. The covering may be of any thickness; it is not necessarily uniform, nor is the entire surface necessarily covered. The term “dry coating” as used herein refers to a coating process wherein the particle to be coated is coated in its dry form, the process does not require dispersing the particles in a continuous liquid phase prior to coating, and at the conclusion of the process the particle has no substantial gain in moisture level relative to its uncoated form. The terms “coating” and “dry coating” are used interchangeably herein. As used herein, the term coating does not necessarily imply that the coated particle has been protected from oxidation or diffusion of volatile materials through the coating.

The term “loading” as used herein, refers to the process of heavily coating a particle of the invention with a liquid, such that the loaded liquid will comprise a significant percentage of the final composition of loaded particles.

The term “encapsulating” as used herein refers to a process for coating a solid particle so that the coating will encase the particle, at least to some extent, in such a manner that volatile substances are inhibited from diffusing through the encapsulation material, and oxidation of the encapsulated particle is inhibited. In addition, the moisture level of the encapsulated product is substantially the same as the unencapsulated starting particle. Volatile substances include, for example, water vapor that may diffuse into the food particle from the atmosphere, or water vapor from the food particle that may diffuse out of the food particle. In either case, freshness of the food particle will be impaired by such diffusion. Other volatile substances such as aromas or flavors are inhibited by the encapsulation layer from diffusing out of the food or flavor particle; additionally, oxidizing volatile substances which could lead to oxidation and impairment of the quality of the food particle, and atmospheric volatile substances which could lead to the food particle taking on “off tastes”, are inhibited from diffusing into the food particle by the encapsulation layer.

The term “inhibiting” or “to inhibit” means that the value being measured is lessened or is diminished, rather than necessarily being completely eliminated or brought to zero.

The term “moisture level” as used herein refers to the amount of moisture, for example water or solvent, that is present in the food particles before or after encapsulation or coating.

The term “oxidation” as used herein refers to the process wherein the atoms in an element lose electrons and the valence of the element is correspondingly increased resulting in destruction of fat soluble vitamins, loss of natural colors, decrease or change in aroma and flavor, and creation of toxic metabolites.

The term “size” as used herein refers to the longest diameter or longest axis of the particle being encapsulated.

The term “volatile” as used herein refers to a compound or material that is readily vaporizable at a relatively low temperature. “Volatiles” may refer, for example, to the aroma volatiles within foods, to volatiles in the environment that may diffuse into foods and cause an “off” taste or smell, or to water moisture in vapor form.

The present invention concerns a process for encapsulating a food particle with a liquid encapsulating material, the process comprising the steps of:
(a) metering a liquid encapsulating material into a flow restrictor;
(b) injecting a gas stream through the flow restrictor concurrently with step (a) to (i) atomize the liquid encapsulating material and (ii) create turbulent flow of the gas stream and the atomized liquid encapsulating material, wherein the gas stream is optionally heated; and
(c) adding a food particle to the region of turbulent flow concurrently with steps (a) and (b), wherein the food particle mixes with the atomized liquid encapsulating material to provide an encapsulated food particle.

Thus, the claimed process is unlike a fluidized bed process, in which the particles to be coated are recirculated within the bed to ensure a prolonged residence time in the treating vessel in order to obtain adequate coating. Indeed, the process of the invention can be considered as a substantially “one pass” process with an extremely short residence time in the region in which encapsulation occurs.

In another aspect, the above-described process further comprises repeating steps (a)-(c) at least once wherein the liquid encapsulating material is the same or different.

In an additional embodiment, the food particles to be encapsulated can be added directly into the flow restrictor within the liquid encapsulating composition, wherein the food particles will enter the turbulent flow region together with the encapsulating material in a single feed composition. In the zone of turbulence the liquid is atomized, thus encapsulating the food particle. This embodiment assumes that the food particle is not insoluble in, or that its quality will not be damaged by, immersion in the liquid encapsulating material. In this embodiment, the usual entry point of particles from an external hopper will be sealed.

Further, instead of encapsulating an encapsulated particle a second (or additive) time, the encapsulated particle may be coated with any number of materials. See, for example, co-pending, co-owned application Attorney Docket number CL 1879 filed Jun. 19, 2002, wherein coating of cereal particles is described; or co-owned, concurrently-filed provisional applications Attorney Docket numbers CL 2101, 2148 and 2149 which describe coating and encapsulating soy products, PUFAs and other materials. Thus, food particles, for example, could be encapsulated with a succession of encapsulation materials, or could be further coated in combinations such as sucrose and fat, gelatin and fat, gelatin and sucrose, wax and sucrose, fat and other sweeteners, fat and salts, and other flavorings, etc., thus enabling unique combinations of volatility protective agents and coating materials to achieve desired colors, tastes, aromas, etc. in preserved food particle products. The process of the invention, when practiced using multiple encapsulations and coatings, can lead to uniquely tailored food particles because each encapsulation or coating has the ability to retain its original integrity and function in that there is minimal “mixing” of subsequent layers that are applied to the dry food particles.

Additionally, food particles can be further encapsulated multiple times with the same liquid encapsulating material, enabling the claimed process to yield food particles having particularly controlled thickness of the encapsulating material to achieve the desired level of inhibition of diffusion and preservation of the particle. Food particles that are encapsulated multiple times with the same liquid encapsulating material can be encapsulated in a continuous loop process, or a batch-wise process. It is also possible to provide multiple encapsulations to a food particle by delivering the output of a first apparatus to the feed of a second apparatus in a continuous process.

It will also be obvious to those skilled in the art that the food particle to be encapsulated in the claimed process may contain a coating that has been previously applied.

There are several benefits of the instant process. Applicants believe the process of the instant invention is more cost efficient than currently conducted food encapsulation processes, which commonly depend upon spray drying, spray chilling, extrusion, fluid bed, or coacervation techniques. Further, in one particularly important aspect, the instant process has the flexibility to be operated successively as a batch process with easily modified batch volumes and batch time periods. Overall food quality is improved over conventional techniques since this is a dry encapsulation process, wherein the liquid encapsulation and drying step occur during the same pass of the food particle through the apparatus of the invention. Thus, there is reduced time of liquid residence on the particle, resulting in reduced opportunity for microbial contamination. Overall food quality is also improved in that food particles that have been encapsulated with the instant process have been observed to retain their morphology, structural integrity, and particle size throughout the process. And importantly, volatiles that produce a food's aroma, flavor, and original moistness are significantly protected through the encapsulation process, and environmental undesirable volatile materials are inhibited from diffusing into the food particles. Further, the food particle is significantly protected from environmental oxidative processes that can degrade food quality.

The flexibility that is inherent in the operation of the apparatus and process of the invention can result in production of high quality encapsulated food particles having carefully controlled and unique characteristics. For example, concentration values of the encapsulating liquid, flow rates of the solid particle feed and the liquid encapsulating feed, ratios of the liquid feed to solid feeds, and temperature and velocity of the gas streams can all be easily varied to yield encapsulated food particles with particular desired characteristics.

Any food particle can be encapsulated using the process of the invention. Examples of such particles include, but are not limited to, particles comprised entirely of foods or flavorings such as coffee grounds, flavoring agents, food ingredients, powdered dairy products, powdered soup products, powdered snack foods, powdered drink mixes, powdered health and fitness supplements, or baking goods. Additionally, the process of the invention can be used to encapsulate food particles that have been formed by coating or loading a core food or nonfood particle with a food or flavoring using the process of the invention. The process of the invention can also be used to encapsulate food particles that have been coated or loaded using other particle coating or loading techniques known in this art. For example, the core particle may be a food particle, such as spice particles or grains of a seasoning salt, for example, which are individually coated with another liquid or solid food or flavoring prior to being encapsulated by the process of the invention; or alternatively, the particle may be comprised of a nonfood material, such as silica or titanium dioxide which is loaded or coated with a food or flavoring prior to being encapsulated by the process of the invention, when such core nonfood particles are recognized as safe for ingestion in the human or animal market for which the encapsulated food particle is destined.

Coffee grounds are powered or granular particles resulting from the process of grinding coffee beans.

Flavoring agents include, but are not limited to, combinations of aromatic chemicals, essential oils, and/or natural extracts, and further include sweeteners (both natural and artificial), seasonings, and spices.

Food ingredients include, but are not limited to, acids, bases, buffers, lipids, enzymes, microorganisms, antioxidants, preservatives, pigments and dyes, anti-caking agents, essential oils, minerals, amino acids, peptides, and vitamins.

Powdered dairy products include, but are not limited to, powdered milk, powdered cheese, powdered cream, powdered casein, powdered lactose, powdered yogurt, powdered egg product, and powdered whey drying process wherein the dried soup product can be reconstituted by the addition of water.

Powdered snack foods comprise any of the above or below described food products used for light meals or for eating between meals.

Powdered drink mixes include, but are not limited to, instant coffee, powdered cocoa, powdered tea, powdered fruit drinks, powdered infant formulas, and powdered non-dairy creamers.

Powdered health and fitness supplements include, but are not limited to, protein products, vitamin supplements, fiber supplements, mineral supplements, dietary supplements, and powdered herbals.

Baking goods include, but are not limited to, corn starch, baking soda, baking powder, baking yeast, dried cake mixes, powdered chocolate, powdered fruits, and powdered vegetables.

Suitable core food or nonfood particles which can be loaded or coated with food or flavoring prior to being encapsulated by the process of the invention include, for example, silica, titanium dioxide, cellulosic flours, etc.

Suitable liquid encapsulating or coating materials will be those which can be used in any food application such as any food, nutritional supplement, beverage, infant formula and the like. Applications intended for human consumption should generally utilize materials that are generally recognized as safe (“GRAS”). If the intended application is for incorporation into a pet food or animal feed, then other liquid encapsulating or coating materials may be suitable. For example, some materials recognized as GRAS include but are not limited to the following: polysaccharides/hydrocolloids such as starch, agar/agarose, pectin/polypectate, carrageenan and other gums; proteins such as gelatin, casein, zein, soy and albumin; fats and fatty acids such as mono-, di-, and triglycerides, lauric, capric, palmitic and stearic acid and their salts; cellulosic derivatives; hydrophilic and lipophilic waxes such as shellac, polyethylene glycol, carnauba wax or beeswax; sugar derivatives, etc.

Examples of such liquid encapsulating or coating materials include, but are not limited to, a sweetening agent, a food flavoring agent or enhancer, a food color, a food aroma agent, an anti-caking agent, an humectant, an antimicrobial agent, an antioxidant, a surface modifying agent, a carbohydrate, a protein, a lipid, a mineral, or a nutritional supplementing agent.

Examples of sweetening agents include, but are not limited to, sugar substitutes such as saccharin, cyclamate, monellin, thaumatins, curculin, miraculin, stevioside, phyllodulcin, glycyrrhizin, nitroanilines, dihydrochalcones, dulcin, suosan, guanidines, oximes, oxathiazinone dioxides, aspartame, alitame, and the like. There can also be mentioned monosaccharides and oligosaccharides. Examples of monosaccharides include, but are not limited to, galactose, fructose, glucose, sorbose, agatose, tagatose and xylose. As oligosaccharides there can be mentioned, sucrose, lactose, lactulose, maltose, isomaltose, maltulose, saccharose and trehalose. Other sweetening agents that can also be used include, but are not limited to, high fructose corn syrup.

Examples of food flavoring agents or enhancers include, but are not limited to, monosodium glutamate, maltol, 5′-mononucleotides, such as inosine, and the like.

Examples of food colors include, but are not limited to, tartrazine, riboflavin, curcumin, zeaxanthin, β-carotene, bixin, lycopene, canthaxanthin, astaxanthin, β-ap-8′-carotenal, carmoisine, amaranth, Ponceau 4R (E124), Carmine (E120), anthocyanidin, erythrosine, Red 2G, Indigo Canine (E132), Patent Blue V (E131), Brilliant blue, chlorophyll, chlorophyllin copper complex, Green S (E142), Black BN (E 151), and the like.

Examples of food aroma agents include, but are not limited to, carbonyl compounds, pyranones, furanones, thiols, thioethers, di- and trisulfides, thiophenes, thiazoles, pyrroles, pyridines, pyrazines, phenols, alcohols, hydrocarbons, esters, lactones, terpenes, volatile sulfur compounds and the like.

Examples of an anti-caking agents include, but are not limited to, sodium, potassium, calcium hexacyanoferrate (II), calcium silicate, magnesium silicate, tricalcium phosphate, magnesium carbonate and the like.

Examples of humectants include, but are not limited to, 1,2-propanediol, glycerol, manitol, sorbitol and the like.

Examples of antimicrobial agents include, but are not limited to, benzoic acid, PHB esters, sorbic acid, propionic acid, acetic acid, sodium sulfite and sodium metabisulfite, diethyl pyrocarbonate, ethylene oxide, propylene oxide, nitrite, nitrate, antibiotics, diphenyl, o-phenylphenol, thiabendazole and the like.

Examples of antioxidant agents include, but are not limited to, tocopherols, 2,6-di-tert-butyl-p-cresol (BHT), tert-butyl-4-hydroxyanisole (BHA), propylgallate, octylgallate, dodecylgallate, ethoxyquin, ascorbyl palmitate, ascorbic acid and the like.

Examples of surface modifying agents include, but are not limited to, mono-, diaglycerides and derivatives, sugar esters, sorbitan fatty acid esters, polyoxyethylene sorbitan esters, stearyl-2-lactylate and the like.

Examples of nutritional supplementing agents include, but are not limited to, vitamins group consisting of fat soluble vitamins group consisting of retinol (vit A), calciferol (vit D), tocopherol (vit E), phytomenadione (vit K1), water soluble vitamins group consisting of thiamine (vit B1), riboflavin (vit B2), pyridoxine (vit B6), nicotinamide (niacin), pantothenic acid, biotin, folic acid, cyanocobalamin (vit B12), ascorbic acid (vit C), polyunsaturated fatty acids (PUFA), and the like.

Other carbohydrates which can be used in a liquid coating material include polysaccharides such as agar, alginates, carrageenans, furcellaran, gum arabic, gum ghatti, gum tragacanth, karaya gum, guaran gum, locust bean gum, tamarind flour, arabinogalactan, pectin, starch, modified starches, dextrins, cellulose, cellulose derivatives, hemicelluloses, xanthan gum, scleroglucan, dextran, polyvinyl pyrrolidone and the like.

Examples of lipids include, but are not limited to, saturated and unsaturated fatty acids, mono- and diacylglycerols triacylglycerols, phospholipids, glycolipids, phosphatidyl derivatives, glycerolglycolipids, sphingolipids, lipoproteins, diol lipids, waxes, cutin and the like.

Examples of minerals include, but are not limited to, salts of sodium, potassium, magnesium, calcium, chloride, phosphate, iron, copper, zinc, manganese, cobalt, vanadium, chromium, selenium, molybdenum, nickel, boron, silica, silicon, fluorine, iodine, arsenic and the like.

Other examples of GRAS encapsulating materials include, but are not limited to, solutions of sweetening agent such as sucrose or maltodextrose, solutions of proteins such as zein, casein, gelatin, soy protein, whey proteins, solutions of fat such as hydrogenated soybean oil, or solutions of an inorganic material such as sodium chloride, or slurries of materials such as titanium dioxide in water.

Other encapsulating materials include without limitation a moisture barrier material, a shelf-life extending agent, a flavor retaining agent.

In another aspect this invention concerns any encapsulated food particle made using the process of this invention.

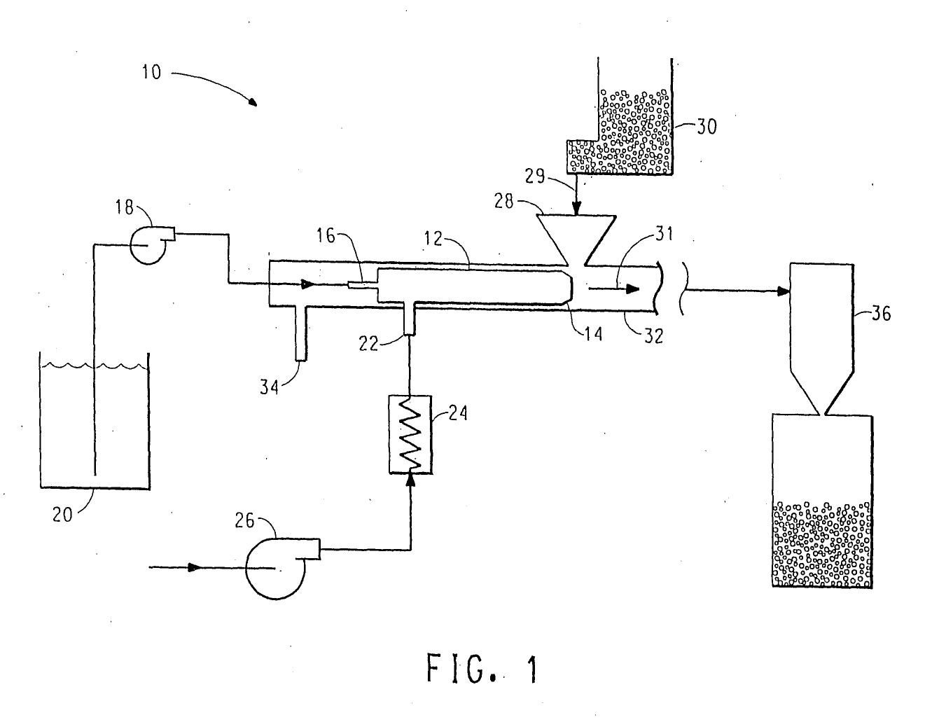

A preferred apparatus used to practice the process of this invention is generally described in commonly owned PCT application WO 97/07879, which is discussed above. A preferred apparatus according to the present invention is shown generally at 10 in FIG. 1 and in FIG. 2.

Referring now to FIGS. 1 and 2:

A first chamber is shown at 12 in FIGS. 1 and 2. A flow restrictor 14 is disposed at one end of the first chamber. The flow restrictor is typically disposed at the downstream end of the first chamber, as shown in FIGS. 1 and 2. Flow restrictor 14 has an outlet end 14a, as shown in detailed view of FIG. 2. Although the flow restrictor is shown as a different element from the first chamber, it may be formed integrally therewith, if desired. The flow restrictor of the present invention may have various configurations, as long as it serves to restrict flow and thereby increase the pressure of the fluid passing through it. Typically, the flow restrictor of the present invention is a nozzle.

A first, or liquid, inlet line 16 as show in FIGS. 1 and 2 is disposed in fluid communication with the first chamber for metering a liquid composition into the chamber. Liquid inlet line 16 meters the liquid composition into the first chamber 12 in the outlet flow restrictor 14, and preferably in the center of the flow restrictor when viewed along the axial length thereof. The liquid composition is metered through liquid inlet line 16 by a metering pump 18 from a storage container 20 containing the liquid composition as shown in FIG. 1.

The liquid composition may be a solution, where a material that is used as the encapsulating material is dissolved in a liquid, or a slurry, or an emulsion where a material that is used as the encapsulating material is undissolved in a liquid. Alternatively, the liquid composition may be a melt, which is used as the encapsulating material. By melt is meant any substance at a temperature at or above its melting point, but below its boiling point. In any of these cases, the liquid composition may include components other than the encapsulating material. It should be noted that when the liquid composition is a melt, storage container 20 must be heated to a temperature above the melt temperature of the liquid composition in order to maintain the liquid composition in melt form.

A second, or gas, inlet line 22 is disposed in fluid communication with the first chamber as shown in FIGS. 1 and 2. Generally, the gas inlet line should be disposed in fluid communication with the first chamber upstream of the flow restrictor. Gas inlet line 22 injects a first gas stream through the flow restrictor to create a stream of turbulent flow. The turbulence subjects the liquid composition to shear forces that atomize the liquid composition.

The first gas stream should have a stagnation pressure sufficient to accelerate the gas to at least one-half the velocity of sound, or greater, prior to entering the flow restrictor to ensure that a flow of turbulence of sufficient intensity will be formed at the outlet of the flow restrictor. The velocity of sound for a particular gas stream, e.g., air or nitrogen, will be dependent on the temperature of the gas stream. This is expressed by the equation for the speed of sound, C:
C=\sqrt{kgRT}
where:
   k=ratio of specific heat for the gas
   g=acceleration of gravity
   =R universal gas constant
   T=absolute temperature of the gas

Thus, the acceleration of the first gas stream is dependent on the temperature of the gas stream.

As noted above, it is the pressurized gas that causes the atomization of the liquid composition. The pressure of the liquid composition in the liquid inlet line just needs to be enough to overcome the system pressure of the gas stream. It is preferable that the liquid inlet line has an extended axial length before the zone of turbulence. If the liquid inlet line is too short, the flow restrictor becomes plugged.

Means disposed in the second inlet line and upstream of the flow restrictor may be employed for optionally heating the first gas stream prior to injection through the flow restrictor. Preferably, the heating means comprises a heater 24 as shown in FIG. 1. Alternatively, the heating means may comprise a heat exchanger, a resistance heater, an electric heater, or any type of heating device. Heater 24 is disposed in second inlet line 22. A pump 26 as shown in FIG. 1 conveys the first gas stream through heater 24 and into first chamber 12. When a melt is used as the encapsulating material, the gas stream should be heated to a temperature around the melt temperature of the melt, to keep the melt in liquid (i.e., melt (form. When using a melt, it is also helpful if auxiliary heat is provided to the first inlet line that supplies the melt prior to injection, to prevent pluggage of the line.

A hopper 28 may be employed as shown in FIGS. 1 and 2. Hopper 28 introduces a particle to the zone of turbulence. It is preferable that the outlet end of the flow restrictor is positioned in the first chamber beneath the hopper at the center line of the hopper. This serves to ensure that the particles are introduced directly into the zone of turbulence. This is important because, as noted above, the turbulence subjects the liquid composition to shear forces that atomize the liquid composition. It also increases operability by providing a configuration for feeding the particles most easily. In addition, the shear forces disperse and mix the atomized liquid composition with the particles, which allows the particles to be encapsulated. Hopper 28 may be fed directly from a storage container 30 as shown by arrow 29 in FIG. 1. The hopper may include a metering device for accurately metering the particles at a particular ratio to the liquid feed from liquid inlet line 16 into the zone of turbulence. This metering establishes the level of encapsulation on the particle. Typically, the hopper is open to the atmosphere. When a melt is used, it is preferred that the particles are at ambient temperature because this facilitates solidification of the melt after the melt that is initially at a higher temperature encapsulates the particle in the zone of turbulence.

A second chamber 32 surrounding the first chamber is shown in FIGS. 1 and 2. In addition, the second chamber encloses the region of turbulent flow of the atomized encapsulating liquid and the food particles, referred to herein alternatively as the zone of turbulence. Second chamber 32 has an inlet 34 for introducing an optional second gas stream into the second chamber. The inlet of the second chamber is preferably positioned at or near the upstream end of second chamber 32. The outlet of second chamber 32 is connected to a collection container, such as that shown at 36 in FIG. 1. The second gas stream acts to reduce any tendency for recirculation within the region of turbulent flow and cools and conveys the encapsulated particles toward the collection container as illustrated by arrow 31 in FIG. 2. In particular, when a solution or slurry is used, the solid of the solution or slurry cools between the zone of turbulence and container so that by the time the particle reaches the container, a solid encapsulation comprising the solid of the solution or slurry is formed on the particle. When a melt is used, the liquid composition cools in the zone of turbulence so that by the time the particle reaches the container, a solid encapsulation comprising the melt is formed on the particle. The first gas stream, as well as the second gas stream, is vented through the top of collection container 36.

For the configuration as shown in FIGS. 1 and 2, inlet 34 may be connected to a blower, not shown, which supplies the second gas stream to the second chamber. The blower and second chamber 32 may be eliminated, however, and the first gas stream may be used to cool the particles and to convey them to container 36. In this case, the solid from the solution, slurry, or melt cools and solidifies on the particle in the atmosphere between the zone of turbulence and the collection container, and the encapsulated particles fall into collection container 36.

It is preferable that the axial length of the zone of turbulence is about ten times the diameter of the second chamber. This allows the pressure at the outlet of the flow restrictor to be at a minimum. Particles are fed into second chamber 32 as shown in FIGS. 1 and 2 near the outlet of the flow restrictor, which is preferably positioned at the center line of the hopper. If the pressure at the outlet is too great, the particles will back flow into the hopper.

When employed, the second gas stream preferably should have sufficient pressure to assist in conveying the encapsulated particles from the zone of turbulence to the collection zone, but should be at lower than the pressure of the first gas stream. This is because a high relative velocity difference between the first gas stream and the second gas stream produces a sufficient degree of turbulence to encapsulate the particles.

It should be noted that the process of the present invention may be practiced using the apparatus illustrated in FIGS. 1, 2, and 3, although it should be understood that the process of the present invention is not limited to the illustrated apparatus. As mentioned above, the process provides a 1-step process, whereby materials to be encapsulated are fed into the apparatus, encapsulated, and collected without need of separation and/or filtration of the solids from liquids. Moreover, it should be noted that while one pass, or cycle, of the process of the present invention may be sufficient to functionally encapsulate the particle, more than one pass may be desirable to adhere additional encapsulating material to the particle, depending on the desired thickness of the encapsulation.

A preferred process comprises the steps of metering a liquid composition into a flow restrictor, such as flow restrictor 14 as shown in FIGS. 1 and 2; injecting a gas stream, for instance from a gas inlet line such as that shown at 22 in FIGS. 1 and 2, through the flow restrictor concurrently with metering the liquid composition into the flow restrictor, to create a region of turbulent flow, also referred to herein as a zone of turbulence, and adding a particle to the zone of turbulence concurrently with the metering of the liquid composition and the injection of the gas stream.

The gas stream is preferably controlled prior to injecting it through the flow restrictor. The gas stream may be heated by a heater, such as heater 24 as shown in FIG. 1. As noted above, when the liquid composition is a solution or slurry, the gas stream is heated to a temperature sufficient to vaporize the liquid of the solution or slurry and to leave the solid of the solution or slurry remaining. When the liquid composition is a melt, the gas stream should be heated to a temperature around the melt temperature of the liquid composition, to keep the liquid composition, and in particular, the melt, in liquid (i.e., melt) form. When using a melt, it is also helpful if auxiliary heat is provided to the first inlet line that supplies the melt prior to injection, to prevent pluggage of the line.

Mixing at the zone of turbulence occurs and encapsulates the particle with the encapsulating material. The particle is preferably metered in order to control the ratio of the particle and the liquid added at the zone of turbulence. This establishes the level of encapsulation on the particle. When a solution or slurry is used, the heat from the heated gas stream serves to evaporate the liquid of the solution or slurry, leaving the solid of the solution or slurry remaining to encapsulate the particle. The mixing at the zone of turbulence then encapsulates the particle with the remaining solid from the solution or slurry. When a melt is used, the mixing at the zone of turbulence encapsulates the particle with the melt.

As noted above, the zone of turbulence is formed by the action of injecting the gas at high pressure through the flow restrictor.

The residence time of the particles in the zone of turbulence is determined by the geometry of the first chamber and the amount of gas injected from the gas inlet line. The average residence time of the particle within the zone of turbulence is preferably less than 250 milliseconds. More preferably, the average residence time of the particle within the zone of turbulence is in the range of 25 to 250 milliseconds. Short residence times can be achieved because of the action of the zone of turbulence. The short residence times make the process of the present invention advantageous compared to conventional encapsulation processes because the time, and hence, the cost of encapsulating particles, are reduced. Further, the present invention can encapsulate particles of a significantly smaller size compared to processes in the prior art. Typically, the particles are fed from a hopper, such as hopper 28 as shown in FIGS. 1 and 2, which is open to the atmosphere. As noted above, when the liquid composition is a melt, it is preferred that the particles be at ambient temperature because this will facilitate solidification of the melt after the melt (which is initially at a higher temperature) encapsulates the particle in the zone of turbulence.

The process of the present invention may further comprise the step of adding another gas stream upstream of the zone of turbulence for cooling and conveying the encapsulated particle. This other gas stream is added through a chamber, such as second chamber 32 as shown in FIGS. 1 and 2. As explained above, the pressure of the second gas stream must be sufficient to assist in conveying the encapsulated particles from the zone of turbulence to the collection container, but should be at lower than the pressure of the first gas stream in order to achieve encapsulation. When a solution or slurry is used, the solid of the solution or slurry cools and solidifies on the particle in the second chamber between the zone of turbulence and a collection container, such as collection zone 36 as described above. When a melt is used, the melt cools and solidifies on the particle in the second chamber between the zone of turbulence and the collection container. When a second chamber is not included, the solid or the melt cools and solidifies on the particle in the atmosphere between the zone of turbulence and the collection container, and the encapsulated particles fall into the container.

The encapsulating materials are generally liquid in nature and can be single or multiple chemical compositions. Thus, they may be pure liquids, solutions, suspensions, emulsions, melted polymers, resins, and the like. These materials generally have viscosities in the 1 to 2,000 centipoise range. Encapsulations that are applied can be hydrophilic, hydrophobic, or amphoteric in nature, depending on their chemical composition. When more than one encapsulation is applied, it can be either as another shell adhering to the previous encapsulation, or as individual particles on the surface of the material to be encapsulated. These materials may also be reactive so that they cause the material they are encapsulating to increase in viscosity or change to a solid or semi-solid material. So that the encapsulation formed on the selected material is in the range stated above, the encapsulating material should be capable of being molecularly dispersed, so that the encapsulation can grow from the molecular level.

The apparatus as shown in FIGS. 1, 2, and 3 can be used for a number of processes. One such process is that of encapsulating corn syrup solids with sweeteners, flavorings, colorants, and the like. In this process, the food particle enters the apparatus and the material that will be used to encapsulate the food particles is fed into the apparatus through the hopper into the high shear/turbulence zone. The resulting atomized encapsulation material encapsulates the surface of the food particle as it is pneumatically transported through the apparatus. The temperature of the process is at least 5° C. higher than the vapor temperature of the solvent at the process operating pressure, so that the volatile materials in the encapsulating mixture (e.g., water) are vaporized within a matter of milliseconds. The encapsulated corn syrup solid is then transported out of the apparatus in a substantially dry state, such that there is substantially no net moisture gain from one end of the process to the other.

A convective drying process may be used for removing residual volatiles that result from putting a solution, slurry, or emulsion encapsulation onto the surface of a food particle. Generally, the particle size of the encapsulated solids exits the process as a dry and disperse product with the same particle size as the substrate plus encapsulation thickness. The design of the process precludes wet particles from reaching any wall to which they may stick, which improves the cleanliness of the system, and may also include a recycle system that can reduce any interparticle or particle-to-wall sticking that might otherwise occur. This process may be selected from any number of methods, including but not limited to flash drying, pneumatic conveyor drying, spray drying, or combinations thereof. Residence times for drying are generally less than a minute and preferably in the millisecond time frame.

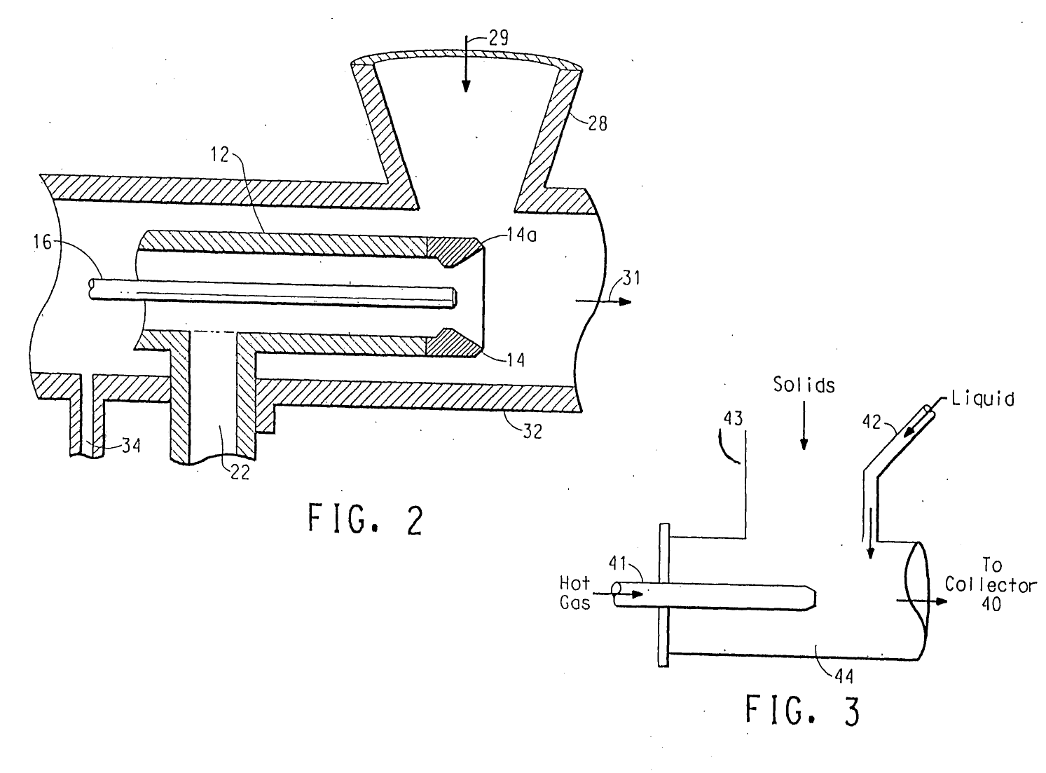

As shown in FIG. 3, the apparatus of FIGS. 1 and 2 can have an alternate configuration. Solids enter the apparatus through hopper 43. Liquid is added via a liquid inlet tub 42 located at the top of the apparatus so that the liquid exists into the high shear/turbulence zone. Hot gas enters chamber 44 through nozzle 41. Produce outlet from chamber 44 exits to collector 40. This configuration can allow for faster changes of liquid used for encapsulation and is less expensive to maintain.

Encapsulated particles of the invention will have many utilities across several industries, but particularly within the food, nutrition, and health sectors. For example, encapsulation may be employed to improve or maintain the nutritional content of food products; prevent flavor loss by preventing moisture contamination or oxidation; prevent the absorption of off-flavors into the encapsulated liquids; extend shelf-life and stability; and deliver food ingredients at the appropriate time during processing, storage, or use.

Further, encapsulation of food, nutrition, and health products into particle form greatly facilitates the ease of storage, measurement, and delivery of these materials. Processing of powdered liquids can be convenient. Packaged dry products will have a lower water activity than products containing the same water content, but in a free or unencapsulated state. The encapsulated food particles will have greater shelf life and less risk of spoilage due to microbial proliferation.

### EXAMPLES

The invention is further described by the following examples, which are provided for illustration and are not to be construed as limiting the scope of the invention.

Generally, Examples 1 and 2 were developed to demonstrate the efficacy of the encapsulation techniques claimed herein, by employing a “model flavor system” assay that is generally recognized within the Flavor Industry. This assay measures efficacy of encapsulation by measuring the retention of volatile substances within encapsulated particles. For example, a cocktail of volatile ‘probes’ (eg pyrole, diacetyl, etc.) is mixed with corn syrup solids and spray dried. These particles are encapsulated with various materials, using the encapsulation process of the invention. After storage at controlled water activities (Aw=0.11, 0.33), the rate of release of these volatile probes is then measured using a gas chromatography method.

The model data system presents data in the form of:

$$A = ln \frac{c}{{c}_{o}} \qquad ( 1 )$$

where c is the concentration of a volatile species in the food particles at a given time, and cₒ is the initial concentration of the volatile species in a food particle sample.

The data is plotted in the form of A versus time (typically 30-40 days). The slope regressed over the time course of analysis is calculated, and presented as a positive number. This is referred to as x and can be considered the natural logarithm of the increase in the lost volatile fraction per day. It can be determined for a specific volatile probe (e.g. methanol) to follow its release. In addition, x can be determined as an average of all volatiles in a food particle system to assess the overall coating effect. While x is a parameter determined by experimental data and analysis over a defined time period (T), its analytical determination is:

$$x = {\int }_{0}^{T} \frac{ⅆ t}{ⅆ ln ( c / {c}_{o} )} \qquad ( 2 )$$

The above data is generated in a form that is difficult to interpret and use for comparative purposes. Therefore, the derivation form of the data is used, based upon correlation with a simpler dimensionless term that is easier to use in assessing the retentive properties of an encapsulated particle.
Definition of ψ

ψ is defined as the propensity to retain a volatile species. The calculation of ψ follows:

$$Ψ = [ \frac{{x}_{control}}{x} - 1 ] \qquad ( 3 )$$

where, x_{control} relates to the uncoated food particle system, or alternatively it is the x value of the uncoated food particle after purging through the system without application of a coating agent. Careful choice of the relevant control is important, since some very volatile species are lost simply through exposure to the heat in the process under certain operating conditions.

ψ gives the ratio of the values for control divided by the encapsulated particles and normalized about the origin. Recall x is the natural logarithm of the increase in the lost volatile fraction of the test particles.

Interpretation of ψ

Equal propensity to retain volatiles (vs. control) ψ=0
Double the propensity to retain volatiles ψ=1
Three times the propensity to retain volatiles ψ=2
Acceleration of loss of volatiles −1<ψ<0
   ie positive ψ indicates retention of volatiles at rates more than the control
negative ψ indicates volatiles are lost from particles faster than the control (reverse of encapsulation, if that is possible).

### Case 1

If volatiles are lost slower than the control (encapsulation retains volatiles)
ψ→∞

### Case 2

If volatiles are lost at the same rate as the control
Ψ=0

### Case 3

If volatiles are lost faster than control
ψ→−1

Notice that the dimensionless parameter ψ is most sensitive to an increase in the retention of volatiles. This was preferred since useful encapsulation should slow down the rate of release of volatiles—not accelerate it. The data provided below in Examples 1 and 2 are interpreted based upon this theoretical basis.

### EXAMPLE 1

### Sucrose Encapsulated Corn Syrup Solids

Materials and drying process: An aqueous slurry of a 25 dextrose equivalent corn syrup solid (“CSS”; Maltrin M-250, Grain Processing Corp., Muscatine, Iowa) was prepared the day before drying (40% solids). This assured complete hydration of the carrier. Volatiles were added to the hydrated matrix immediately prior to spray drying and then homogenized using a Greerco high shear mixer. The volatiles used and their initial concentrations are listed in Table 1.

TABLE 1
Volatiles used in model volatile system

| | | | | | |
|---|---|---|---|---|---|
| Ethyl- | Methyl | Ethyl | Propyl | Hexane | Ethyl |
| mercaptan | Formate | Formate | Formate | 1000 ppm | Acetate |
| 1000 | 1500 ppm | 1500 ppm | 1500 ppm | | 1500 ppm |
| ppm* | | | | | |
| Ethanol | Propanol | Diacetyl | Pentanedione | Limonene | Furfural |
| 3000 ppm | 5000 ppm | 3000 ppm | 3000 ppm | 3000 ppm | 5000 ppm |
| Acetal- | Acetone | Propanal | Butanal | Methanol | Pyrrole |
| dehyde | 2000 ppm | 1000 ppm | 1000 ppm | 5000 ppm | 4000 ppm |
| 1000 ppm | | | | | |

*based on solids

The aromatized matrices were spray dried in a tower dryer at 204° C. inlet and 88° C. exit air temperatures. This dryer uses a pressure spray atomizer (Spray Systems nozzle 69/20 insert at 400 psi pressure). Sample encapsulation: Samples of CSS containing spray dried volatiles were encapsulated using the apparatus as shown in FIG. 1. The apparatus had a mixing chamber 32 mm in diameter and 300 mm in length with a nozzle throat of 10 mm and a central liquid feed tube of 6.5 mm O.D. and 4.8 mm I.D. The apparatus has a single screw metering feeder (AccuRate) or a vibrating feeder (Syntron) for metering the solid particles. A peristaltic pump was fit with 6.5 mm Tygon elastomer tubing for metering the liquid. CSS containing spray dried volatiles was metered to the system in a range of 1000-1300 grams/min (“g/min”). Sucrose syrup was at 95° C. and was metered in a range of 100-170 g/min to the center tube using the peristaltic pump. Nitrogen gas was supplied to the nozzle at 414 KPa and was at 22° C. at the nozzle. The nitrogen gas was used to atomize the sucrose syrup, producing a negative pressure in the mixing zone to induce the addition of the CSS, and to provide the heat for evaporating any residual moisture from the CSS. The product of the mixing/drying was collected in a polyester twill bag filler immediately downstream of the 14 inch conveying tube. The samples had a sucrose encapsulation equal to 7.6%, 8.0%, and 10.2% of the final mass of the encapsulated particle.

After encapsulation, samples were placed in trays for storage study. Sample trays were made of Plexiglas (10 cm×20 cm×1 cm) with each tray holding about 80 g of CSS at bed depths not exceeding 1 cm. The trays were placed in fish tanks containing saturated salt solutions to provide the desired storage relative humidity. The tanks contained ca. 2 kg of saturated salt solution to provide 0.11 Aw (LiCl) or 0.33 Aw (MgCl₂) environments. The loaded tanks were held in a 35° C. incubator throughout storage. A sample of each powder was also stored in a closed glass jar at 29° C.

Sample analysis: Selected samples were analyzed for water activity throughout storage. Samples were analyzed for volatiles by gas chromatography (“GC”) using static headspace techniques (Agilent Headspace Sample 7694). The operating conditions are as follows:

GC Operating Conditions
GC model: 5890
Column: DB-wax, 30 m×0.25 mm×0.25 μm (J & W Scientific)
Injection: split liner, split ratio 31:1
GC column head pressure: 15 psi
Oven: 40° C./6 min/5° C./min to 200° C. for 5 min
Detector: H₂: 40 ml/min; Air: 450 ml/min

Headspace Sampler Operating Conditions
Agilent Headspace Sampler 7694
Carrier pressure: 168 psi
Vial pressure: 2.8 psi
Sample size: sample loop 1 ml
Zone temperatures: Oven—60° C., Loop—75° C., Transfer Line—85° C.
Vial equilibration time: 50 min
Pressurization time: 0.5 min
Loop fill time: 0.5 min
Loop equilibration time: 0.5 min
Injection time: 1 min
Vial Parameters: high shake

To determine volatile retention during storage, powder samples (2 g) were reconstituted with water (3 g) for headspace analysis. The samples in storage were analyzed at time 0 and then days 0, 2, 4, 7, 9, 14, 17, 23, 32, and 39. An initial sample of each dried product was saved and stored under frozen conditions to serve as an analytical control.

Since the losses of volatiles through diffusion are quite low at an Aw of 0.11, the results in Table 2 focus on losses during storage at an Aw of 0.33.

Table 2 shows that encapsulation of CSS with a single sucrose coating in percentages of 7.6 and 8.0 had some effect on the volatile loss rates (ψ=0.28 and 0.13) compared to unencapsulated samples. Encapsulation of CSS with a single sucrose coating in a percentage of 10.2 reduced volatile losses to a greater extent (ψ=4.83)

### EXAMPLE 2

### Multiple Encapsulation of Corn Syrup Solids by Sucrose

Samples of spray dried CSS containing volatiles were coated using the apparatus as shown in FIG. 1. The apparatus was operated three times. The product from the experiment A became the solids feed for the experiment B. Similarly the product from the experiment B became the solids feed for the experiment C. This generated an end product with three coating passes. CSS containing spray dried volatiles was metered to the system (A=1269.3, B=1115.3, C=1095.0 g/min). An aqueous solution of 84% Sucrose at 22° C. was metered in a range of (A=123.5, B=125.4, C=107.7 g/min) to the center tube using the peristaltic pump. Nitrogen gas was supplied to the nozzle at 414 kPa and was at 291° C. at the nozzle. The nitrogen gas was used to atomize the sucrose, producing a negative pressure in the mixing zone to induce the addition of the spray dried CSS containing volatiles, and to provide the heat for evaporating any residual moisture from the spray dried CSS containing volatiles. The coated particles were collected in a bag filter as dry, free flowing, dispersed particles. The product samples had a sucrose mass fraction of (A=7.6%, B=15.6%, C=22.0% w/w). Table 2 demonstrates that multiple coatings with sucrose on spray dried CSS reduced volatile losses (ψ=0.15 and 0.76). Some volatile components were retained better than others. The propensity of the sucrose to retain specific volatiles varied with the chemical nature of the volatile species. Accordingly, other coating materials are expected to exhibit different propensities to retain specific volatiles.

TABLE 2
Propensity to retain a volatile species ψ of all volatiles for different
coating levels at water activity Aw = 0.33

| | In (lost volatile fraction) × [1/day] | | | | | | | |
|---|---|---|---|---|---|---|---|---|
| | Example 1 | | | | | Example 2 | | |
| | No. of passes | | | | | | | |
| | N/A | Single | | | | Double | Triple | Volatile |
| | Untreated | 0% | 7.6% | 8.0% | 10.2% | 15.6% | 22.0% | retention |
| | CSS | (purge) | sucrose | sucrose | sucrose | sucrose | sucrose | ψ |
| Acetaldehyde | 0.0348 | 0.2720 | 0.0235 | 0.0230 | 0.0187 | 0.0218 | 0.0173 | 0.3 |
| Ethylmercaptan | 0.0253 | 0.0245 | 0.0194 | 0.0162 | 0.0199 | 0.0253 | 0.0208 | 0.2 |
| Methylformate | 0.0094 | 0.0166 | 0.0103 | 0.0094 | 0.0055 | 0.0097 | 0.0072 | 1.1 |
| Propanal | 0.0132 | 0.0148 | 0.0133 | 0.0153 | 0.0109 | 0.0138 | 0.0105 | 0.2 |
| Acetone | 0.0056 | 0.0089 | 0.0054 | 0.0081 | 0.0021 | 0.0062 | 0.0039 | 1.1 |
| Ethylformate | 0.0035 | 0.0083 | 0.0039 | 0.0081 | 0.0018 | 0.0084 | 0.0024 | 1.4 |
| Butanal | 0.0113 | 0.0125 | 0.0116 | 0.0134 | 0.0095 | 0.0121 | 0.0092 | 0.1 |
| Ethylacetate | 0.0028 | 0.0064 | 0.0041 | 0.0066 | 0.0017 | 0.0054 | 0.0027 | 1.0 |
| Methanol | 0.0379 | 0.0571 | 0.0398 | 0.0343 | 0.0288 | 0.0394 | 0.0281 | 0.7 |
| Propylformate | 0.0028 | 0.0060 | 0.0043 | 0.0060 | 0.0020 | 0.0054 | 0.0028 | 0.7 |
| Ethanol | 0.0080 | 0.0143 | 0.0085 | 0.0097 | 0.0030 | 0.0084 | 0.0067 | 1.4 |
| Diacetyl | 0.0121 | 0.0153 | 0.0135 | 0.0140 | 0.0094 | 0.0136 | 0.0110 | 0.3 |
| Propanol | 0.0037 | 0.0066 | 0.0043 | 0.0068 | 0.0001 | 0.0048 | 0.0030 | 13.4 |
| Pentanedione | 0.0136 | 0.0136 | 0.0172 | 0.0104 | 0.0122 | 0.0156 | 0.0155 | 0.0 |
| Limonene | 0.0042 | 0.0011 | 0.0072 | 0.0043 | 0.0033 | 0.0071 | 0.0015 | −0.7 |
| Furfural | 0.0086 | 0.0096 | 0.009 | 0.0104 | 0.0044 | 0.0089 | 0.0069 | 0.3 |
| Pyrrole | 0.0413 | 0.0353 | 0.0352 | 0.0344 | 0.0299 | 0.0320 | 0.0282 | 0.1 |
| Volatile | | 0.0 | 0.28 | 0.13 | 4.83 | 0.15 | 0.76 | |
| retention ψ | | | | | | | | |

### EXAMPLE 3

### Encapsulated Coffee Grounds

Both premium and standard ground coffee were encapsulated with Hi-Melt fat (Dritex) using the procedure described in Example 1 with the following exceptions. Solid feed rate of the premium ground coffee was 382.5 g/min, while the solid feed rate of standard ground coffee ranged from 433.1-468.5 g/min. Liquid feed rate of the Hi-Melt fat ranged from 95-190 g/min. Liquid feed temperature was 80° C. Premium ground coffee had a Hi-Melt fat encapsulation of 25.0% final mass, while standard ground coffee had a Hi-Melt fat encapsulation in the range of 22.9%-40.5%. The Hi-Melt fat produced a moisture barrier around the ground coffee particles.

The moisture-barrier was determined by the following test. Hi-Melt fat encapsulated coffee (1 g) was placed into a beaker of water (150 mL) at room temperature. A portion of the fat encapsulated coffee particles floated on the surface of the water, while the remainder sank below the surface. The beaker was shaken gently and observed for 5 minutes. No substantial change in the color of the water was observed. It was concluded that the coffee was protected from the water by the fat barrier since dissolved coffee would have colored the water. Similarly, Hi-Melt fat coated coffee particles were added to water at 90° C. Within a few seconds, the coffee dispersed into the water and the water took on a dark colored appearance typical of dissolved coffee. It was concluded that the moisture protection of the coffee by fat was not possible above the melting point of the fat barrier (70° C.). Thus, the coffee was delivered to the water for dissolution by a temperature trigger.

### EXAMPLE 4

### Calcium Carbonate Encapsulated with Eudragit

Samples of Calcium Carbonate were coated using the apparatus as shown in FIG. 1. The apparatus was operated three times. The product from the experiment A became the solids feed for the experiment B. Similarly the product from the experiment B became the solids feed for the experiments C. This generated an end product with three coating passes. Calcium Carbonate was metered to the system (A=572.1, B=498.2, C=451.4 g/min). An aqueous dispersion of 30% Eudragit L30 D55 (acrylate polymer for sustained release) at 22° C. was metered in a range of (A=33.7, B=31.7, C=31.0 g/min) to the center tube using the peristaltic pump. Nitrogen gas was supplied to the nozzle at 550 kPa and was at (A=85, B=83, C=78° C.) at the nozzle.

The nitrogen gas was used to atomize the Eudragit L30 D55, producing a negative pressure in the mixing zone to induce the addition of the Calcium Carbonate, and to provide the heat for evaporating any residual moisture from the Calcium Carbonate. The coated particles were collected in a bag filter as dry, free flowing, dispersed particles. The product samples had a Eudragit L30 D55 mass fraction of (A=1.8%, B=3.6%, C=5.5% w/w).

The coating quality was determined by placing the coated particles (0.7 g) into 1 M HCl (150 ml) and observations were recorded with regard to degree of effervesence. The control calcium carbonate (not coated) exhibited immediate and substantial effervesence. The single, double and triple coated samples (A, B, C) indicated progressively less effervesence and in the instance of sample C a delay of onset of effervesence.

1. A process for encapsulating a food particle with a liquid encapsulating material, the process comprising the steps of:
(a) metering a liquid encapsulating material into a flow restrictor;
(b) injecting a gas stream through the flow restrictor concurrently with step (a) to (i) atomize the liquid encapsulating material and (ii) create turbulent flow of the gas stream and the atomized liquid encapsulating material, wherein the gas stream is optionally heated; and
(c) adding a food particle to the region of turbulent flow concurrently with steps (a) and (b), wherein the food particle mixes with the atomized liquid encapsulating material to provide an encapsulated food particle.

2. The process of claim 1, wherein the food particle is selected from the group consisting of coffee grounds, flavoring agents, food ingredients, powdered dairy products, powdered soup products, powdered snack foods, powdered drink mixes, powdered health and fitness supplements, baking goods, and inert food additives.

3. The process of claim 1, wherein the food particle added in step (c) comprises a GRAS nonfood core particle that has been loaded or coated with a food or flavoring material.

4. The process of claim 1, wherein the food particle added in step (c) comprises a food particle that has been loaded or coated with a food or flavoring material.

5. The process of claim 1, wherein the food particle added at step (c) comprises a food particle that has been loaded or coated with a nonfood GRAS material.

6. The process of claim 1, wherein the food particle added at step (c) comprises a spray-dried emulsion of a flavor oil.

7. The process of claim 1, wherein the food particle added at step (c) comprises an extruded emulsion of a flavor oil.

8. The process of claim 1, wherein the liquid encapsulating material comprises a sweetening agent, a food flavoring agent or enhancer, a food color, a food aroma agent, an anti-caking agent, a humectant, an antimicrobial agent, an antioxidant, a surface modifying agent, a moisture barrier, a shelf-life extending agent, a flavor retaining agent, a nutritional supplementing agent, a carbohydrate, a protein, a lipid, or a mineral.

9. The process of claim 1, further comprising repeating steps (a)-(c) at least once wherein the liquid encapsulating material is the same or different.

10. An encapsulated food particle made by the process of any of claims 1-9.
